(19) United States
(12) Patent Application Publication
(10) Pub. No.: US 2016/0252836 A1
(43) Pub. Date: Sep. 1, 2016

(54) ELECTROCONDUCTIVE ROLLER, PROCESS CARTRIDGE, AND ELECTROPHOTOGRAPHIC APPARATUS

(71) Applicant: CANON KABUSHIKI KAISHA, Tokyo (JP)

(72) Inventors: Satoru Yamada, Numazu-shi (JP); Yukinori Nagata, Mishima-shi (JP)

(21) Appl. No.: 15/017,585

(22) Filed: Feb. 5, 2016

(30) Foreign Application Priority Data
Feb. 27, 2015 (JP) 2015-039019

(51) Int. Cl. G03G 15/02; F16C 13/00

(52) U.S. Cl. CPC G03G 15/0233

(57) ABSTRACT

Provided is an electroconductive roller, including: an electroconductive supporting shaft; an adhesive layer on the electroconductive supporting shaft; and an electroconductive layer on the adhesive layer, in which: the adhesive layer contains a phenol resin; the electroconductive layer contains an epichlorohydrin rubber; the electroconductive supporting shaft includes ferrite-based stainless steel.

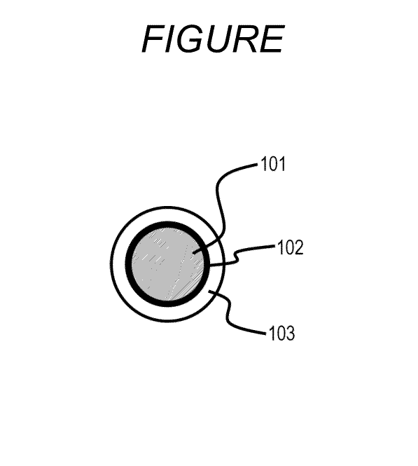

### BACKGROUND OF THE INVENTION

1. Field of the Invention

The present invention relates to an electroconductive roller, and a process cartridge and an electrophotographic apparatus each including the electroconductive roller.

2. Description of the Related Art

In an electrophotographic apparatus serving as an image-forming apparatus adopting an electrophotographic system, an electroconductive roller has been used in various applications. Examples thereof include a charging roller, a developing roller, and a transfer roller. As such electroconductive roller, there is known a roller obtained by laminating an adhesive layer and an electroconductive layer on an electroconductive supporting shaft made of a metal, such as iron.

Incidentally, when an electroconductive roller including an electroconductive layer containing an epichlorohydrin rubber is used under high-temperature and high-humidity conditions over a long time period, its electroconductive supporting shaft is corroded by a chloride derived from chlorine that has been liberated in the electroconductive layer in some cases.

Japanese Patent Application Laid-Open No. 2012-189748 discloses a charging member using stainless steel or the like as its electroconductive supporting shaft, containing a phenol resin as its adhesive layer, and using an epichlorohydrin rubber as its electroconductive layer.

The present invention is directed to the providing an electroconductive roller having the following characteristics. The roller is excellent in adhesive force between an electroconductive layer containing an epichlorohydrin rubber and an electroconductive supporting shaft, and even when the roller is used under high temperature and high humidity, the corrosion of the electroconductive supporting shaft resulting from liberated chlorine hardly occurs. The present invention is also directed to providing a process cartridge and an electrophotographic apparatus conducive to stable formation of high-quality electrophotographic images.

### SUMMARY OF THE INVENTION

According to one embodiment of the present invention, there is provided an electroconductive roller, including: an electroconductive supporting shaft; an adhesive layer on the electroconductive supporting shaft; and an electroconductive layer on the adhesive layer, in which: the adhesive layer contains a phenol resin; the electroconductive layer contains an epichlorohydrin rubber; the electroconductive supporting shaft includes ferrite-based stainless steel; a mass % composition of the ferrite-based stainless steel contains 0.001% to 0.020% of carbon, 0.001% to 0.020% of nitrogen, 0.010% to 0.500% of silicon, 0.050% to 1.000% of manganese, 0.040% or less of phosphorus, 0.010% or less of sulfur, 12.000% to 25.000% of chromium, at least one of titanium and niobium, the titanium being incorporated at a content of from 0.020% to 0.500%, and the niobium being incorporated at a content of from 0.020% to 1.000%, and at least one of tin and antimony, the tin being incorporated at a content of from 0.005% to 2.000%, and the antimony being incorporated at a content of from 0.0050% to 1.000%; and the balance of the composition includes iron and an inevitable impurity.

Further, according to another embodiment of the present invention, there is provided a process cartridge, including: an electrophotographic photosensitive member; and a charging roller arranged to be in contact with the electrophotographic photosensitive member, the process cartridge being removably mounted onto a main body of an electrophotographic apparatus, in which the charging roller includes the above-mentioned electroconductive roller.

According to yet another embodiment of the present invention, there is provided an electrophotographic apparatus, including: an electrophotographic photosensitive member; and a charging roller arranged to be in contact with the electrophotographic photosensitive member, in which the charging roller includes the above-mentioned electroconductive roller.

Further features of the present invention will become apparent from the following description of exemplary embodiments with reference to the attached drawings.

### BRIEF DESCRIPTION OF THE DRAWINGS

FIGURE is a schematic sectional view for illustrating an example of an electroconductive roller according to the present invention.

### DESCRIPTION OF THE EMBODIMENTS

Preferred embodiments of the present invention will now be described in detail in accordance with the accompanying drawings.

An investigation made by the inventors of the present invention has found that in the case where stainless steel excellent in corrosion resistance is used in an electroconductive supporting shaft, an adhesive property between the electroconductive supporting shaft and an electroconductive layer containing an epichlorohydrin rubber involves a problem even when a phenol resin-based adhesive having a high adhesive force is used.

In view of the knowledge that when stainless steel having high corrosion resistance, such as SUS444, is used as an electroconductive supporting shaft, and a phenol resin-based adhesive is used as an adhesive, an adhesive force between the electroconductive supporting shaft and an electroconductive layer containing an epichlorohydrin rubber is insufficient, the inventors of the present invention have made extensive investigations on a material for the electroconductive supporting shaft. As a result, the inventors have found the composition of an alloy suitable for adhesion with the electroconductive layer containing the epichlorohydrin rubber as the material for the electroconductive supporting shaft.

[Electroconductive Supporting Shaft]

An electroconductive supporting shaft of the present invention is ferrite-based stainless steel, the mass % composition of the ferrite-based stainless steel contains 0.001% to 0.020% of carbon, 0.001% to 0.020% of nitrogen, 0.010% to 0.500% of silicon, 0.050% to 1.000% of manganese, 0.040% or less of phosphorus, 0.010% or less of sulfur, 12.000% to 25.000% of chromium, at least one of titanium and niobium, the titanium being incorporated at a content of from 0.020% to 0.500%, and the niobium being incorporated at a content of from 0.020% to 1.000%, and at least one of tin and antimony, the tin being incorporated at a content of from 0.005% to 2.000%, and the antimony being incorporated at a content of from 0.0050% to 1.000%, and the balance of the composition includes iron and an inevitable impurity.

The stainless steel of such composition has high corrosion resistance, and has extremely large resistance to the corrosion of an electroconductive supporting shaft due to chlorine in an electroconductive layer containing epichlorohydrin. Meanwhile, the stainless steel of the composition can express a satisfactory adhesive force with an adhesive layer containing a phenol resin from the initial stage of adhesion.

As the content of carbon becomes lower, the corrosion resistance and moldability of the stainless steel improve. However, excessively reducing the content leads to an increase in cost. Accordingly, the content is from 0.001% to 0.020%.

Nitrogen reduces the moldability, though the element is effective in improving the corrosion resistance. Accordingly, its content is preferably as low as possible. However, as in carbon, excessively reducing the content leads to an increase in cost. Accordingly, the content is from 0.001% to 0.020%.

Silicon reduces the moldability, though the element is effective in improving the corrosion resistance. Accordingly, its content is from 0.010% to 0.500%.

Manganese is an element effective for deacidification. On the other hand, excessive incorporation thereof reduces the corrosion resistance. Accordingly, its content is from 0.050% to 1.000%.

Phosphorus is an element reducing the weldability and workability of the stainless steel. Accordingly, its content is 0.040% or less.

When sulfur is present as a sulfide that easily dissolves, such as calcium sulfide or manganese sulfide, the sulfide is liable to be a starting point for the corrosion of the stainless steel. Accordingly, its content is 0.010% or less.

Chromium is an element extremely important for improving the corrosion resistance. As its content becomes higher, the corrosion resistance improves. On the other hand, as the content becomes higher, the moldability reduces. Accordingly, the content is from 12.000% to 25.000%.

Of the above-mentioned elements, nitrogen, silicon, and chromium are elements important for improving the corrosion resistance. On the other hand, the corrosion resistance obtained merely by adding those elements is insufficient for resisting corrosion caused by a chloride derived from, for example, chlorine that has been liberated in the electroconductive layer containing the epichlorohydrin rubber. Accordingly, titanium, niobium, tin, and antimony need to be added.

In the stainless-steel, titanium or niobium or titanium and niobium is/are contained. Titanium and niobium are elements that improve the corrosion resistance and the moldability. However, excessive incorporation of titanium is responsible for surface defects of the stainless steel at the time of its production. In addition, excessive incorporation of niobium deteriorates the moldability. Accordingly, the content of titanium is from 0.020% to 0.500%, and the content of niobium is from 0.020% to 1.000%.

In the stainless-steel, tin or antimony or tin and antimony is/are contained. Tin and antimony are elements extremely effective in improving the corrosion resistance. However, excessive incorporation of any such element deteriorates the moldability. Accordingly, the content of tin is from 0.005% to 2.000%, and the content of antimony is from 0.005% to 1.000%.

In the present invention, the term “inevitable impurity” refers to a trace component in a raw material or the like. Examples thereof include oxygen, zirconium, lead, bismuth, zinc, vanadium, magnesium, cobalt, nickel, and molybdenum. Stainless steel having added thereto molybdenum has a high suppressing effect on the corrosion caused by a chloride derived from, for example, chlorine that has been liberated in the electroconductive layer containing the epichlorohydrin rubber, but as its content becomes higher, the adhesive force of the stainless steel with the adhesive layer reduces. Accordingly, the content is 0.2% or less.

The composition analysis of materials constituting the electroconductive supporting shaft can be performed by, for example, a fluorescent X-ray analysis method.

More specifically, for example, a fully automatic fluorescent X-ray analyzer (trade name: Axios, manufactured by PANalytical, vessel: end window-type Rh, target: 2.4 kW, measurement environment: vacuum, elements to be measured: boron (B) to uranium (U)) can be used. In addition, quantification is performed from a fluorescent X-ray chart obtained with the fully automatic fluorescent X-ray analyzer by using the “Spectral Evaluation” of the dedicated software (trade name: Super Q MANAGER, manufactured by PANalytical) of the analyzer.

The shape of the electroconductive supporting shaft is as follows: the outer periphery of a sectional shape of a portion to be held by a process cartridge has a circular shape. Examples thereof include a columnar shape, and such a shape that both of its end portions are each of a columnar shape and its central portion has a polygonal shape. In addition, the inside of the electroconductive supporting shaft may be solid, or may be hollow. When the electroconductive supporting shaft has a hollow structure, a cost therefor can be reduced. In addition, its weight is reduced, and hence rigidity which the process cartridge is required to have can be reduced, and a reduction in weight of the process cartridge and the simplification of its construction can be achieved.

The electroconductive supporting shaft can be produced by a known method. Examples thereof include a method involving producing a columnar solid body or a columnar hollow body through drawing, and a method involving producing the columnar hollow body (cylindrical body) through press working from a flat plate. The material described in the foregoing is excellent in press workability, and is hence suitably used. When the columnar hollow body is produced through the press working from the flat plate, seams occur on the outer peripheral surface of the electroconductive supporting shaft, but the seams can be changed in shape, or can be bonded by welding or the like, as required. The electroconductive supporting shaft is specifically, for example, an electroconductive supporting shaft obtained by subjecting a metal plate to press working to form the plate into a cylindrical shape.

[Adhesive Layer]

An adhesive layer of the present invention contains a phenol resin. The phenol resin has low permeabilities to gases, such as water vapor and a chlorine gas, and hence has the effect by which the difficulty with which chlorine in the electroconductive layer containing epichlorohydrin reaches the surface of the electroconductive supporting shaft is raised. The adhesive layer of the present invention may further contain another resin, a rubber, an electroconductive agent, a plasticizer, a thixotropy-imparting agent, a pigment, a dye, an anti-aging agent, an antioxidant, a dispersant, a solvent, and the like in addition to the phenol resin within the range in which the object of the present invention is not impaired.

As the other resin, a resin such as a thermosetting resin or a thermoplastic resin is used. Specific examples of the resin to be suitably used include a urethane resin, an acrylic resin, an amide resin, an olefin resin, and an epoxy resin. Of those, an epoxy resin is particularly suitably used because the resin can trap chlorine that has been liberated from the epichlorohydrin rubber in the electroconductive layer, and hence has a suppressing effect on the corrosion of the electroconductive supporting shaft.

In addition to those resins, for example, any one of the following rubber components may also be mixed for improving the heat resistance of the adhesive layer, and improving an adhesive force between the adhesive layer and the electroconductive layer: a natural rubber, a butadiene rubber, a styrene-butadiene rubber (SBR), a nitrile rubber, an ethylene-propylene rubber (EPDM), a nitrile-butadiene rubber (NBR), a butyl rubber, and a urethane rubber. Of those, a nitrile-butadiene rubber is particularly preferred because the rubber can improve the adhesive force between the electroconductive layer and the adhesive layer.

Examples of the electroconductive agent include: electroconductive particles of carbon black, graphite, electroconductive metal oxides (e.g., electroconductive titanium oxide and electroconductive tin oxide), and the like; and electroconductive composite particles obtained by compositing these electroconductive particles and other particles.

Whether or not the adhesive layer contains the phenol resin can be confirmed by, for example, a pyrolysis GC-MS method or FT-IR.

In addition, an adhesive containing the phenol resin is commercially available as, for example, “METALOC U-20” or “METALOC N-23” (each of which is a trade name, manufactured by Toyokagaku Kenkyusho Co., Ltd.).

The adhesive layer can be formed by an application method, such as roll application, electrostatic spray application, or dipping application. A solvent to be used in an application liquid needs only to be a solvent that can dissolve the phenol resin, and specific examples thereof include the following solvents: ketones, such as acetone, methyl ethyl ketone, and cyclohexanone; ethers, such as tetrahydrofuran, dioxane, and ethylene glycol monomethyl ether; esters, such as methyl acetate and ethyl acetate; and aromatic compounds, such as xylene, chlorobenzene, and dichlorobenzene.

Further, the adhesive layer may contain a fatty acid metal salt, a phosphite, and the like in order that the corrosion of the electroconductive supporting shaft may be suppressed by the adhesive layer.

It has been generally known that when the epoxy resin, the fatty acid metal salt, and the phosphite are mixed, these three kinds of materials react with a halogen atom, such as chlorine, to produce a stable compound, thereby making the halogen atom, such as chlorine, harmless.

[Electroconductive Layer]

An electroconductive layer of the present invention contains an epichlorohydrin rubber. Specific examples of the epichlorohydrin rubber include an epichlorohydrin homopolymer, an epichlorohydrin-ethylene oxide copolymer, and an epichlorohydrin-ethylene oxide-allyl glycidyl ether terpolymer. Each of such polymers is used alone or in combination with another material. Examples of the other material to be used in combination include an acrylonitrile-butadiene copolymer, a hydrogenated acrylonitrile-butadiene copolymer, a silicone rubber, an acrylic rubber, and a urethane rubber.

An electronic electroconductive agent or an ionic electroconductive agent can be added to the rubber forming the electroconductive layer as required for adjusting the electric resistance value of the layer. Examples of the electronic electroconductive agent include carbon black, graphite, oxides, such as tin oxide, metals, such as copper and silver, and electroconductive particles having imparted thereto electroconductivity by covering a particle surface with an oxide or a metal. Examples of the ionic electroconductive agent include materials each having an ion exchange property, such as a quaternary ammonium salt and a sulfonate.

In addition, a filler, a softener, a processing aid, a tackifier, an antitack agent, a dispersant, a foaming agent, roughening particles, and the like, which are generally used as a resin compounding agent, can be added to the rubber within the range in which the effect of the present invention is not impaired. As a guideline, the electric resistance value of the electroconductive layer is 1×10³ Ω·cm or more and 1×10⁹ Ω·cm or less.

Whether or not the electroconductive layer contains the epichlorohydrin rubber can be confirmed by, for example, a pyrolysis GC-MS method or FT-IR.

An electroconductive roller of the present invention can be used as an electroconductive member to be mounted on an image-forming apparatus (electrophotographic apparatus) adopting an electrophotographic process (electrophotographic system), such as a copying machine or a laser printer. Specifically, the roller can be used as a charging roller, a developing roller, a transfer roller, or a charge-eliminating roller, or a conveying member, such as a sheet-feeding roller.

The electroconductive roller of the present invention is described below by way of Examples in each of which a charging roller serving as a typical example of the electroconductive roller is used, but the present invention is not limited thereto. FIGURE is a schematic sectional view of an example of the electroconductive roller according to the present invention (schematic sectional view when the electroconductive roller is cut vertically to the axial direction of the electroconductive supporting shaft). As illustrated in FIGURE, the electroconductive roller of the present invention includes an electroconductive supporting shaft 101, an adhesive layer 102 arranged on its outer periphery, and an electroconductive layer 103 arranged on the adhesive layer 102. In addition, a surface layer may be arranged on the electroconductive layer as required.

Specific examples in each of which the electroconductive roller of the present invention is used as a charging roller include the following process cartridge and electrophotographic apparatus. That is, the process cartridge includes: an electrophotographic photosensitive member; and a charging roller arranged to be in contact with the electrophotographic photosensitive member, the process cartridge being removably mounted onto a main body of an electrophotographic apparatus. Further, the electrophotographic apparatus includes: an electrophotographic photosensitive member; and a charging roller arranged to be in contact with the electrophotographic photosensitive member.

According to one embodiment of the present invention, an electroconductive roller having the following characteristics can be obtained. The roller is excellent in adhesive force between an electroconductive layer containing an epichlorohydrin rubber and an electroconductive supporting shaft, and even when the roller is used under high temperature and high humidity, the corrosion of the electroconductive supporting shaft resulting from liberated chlorine hardly occurs.

The present invention is specifically described below by way of Production Examples and Examples.

[1. Production Examples of Electroconductive Supporting Shafts]

Columnar solid rods formed of materials 1 to 29 of compositions shown in Table 1 below (the compositions were represented in a mass % unit), the rods each having a total length of 252 mm and a diameter of 6 mm, were prepared as electroconductive supporting shafts 1 to 29. It should be noted that the material 29 is SUS444. In addition, flat plates (thickness: 0.6 mm) formed of the material 1 and the material 2 were subjected to press working to prepare columnar hollow rods (cylindrical bodies) each having a total length of 252 mm and a diameter of 6 mm as electroconductive supporting shafts 30 and 31.

TABLE 1

| | Electroconductive supporting shaft No | | | | | | | | | |
|---|---|---|---|---|---|---|---|---|---|---|
| | 1 | 2 | 3 | 4 | 5 | 6 | 7 | 8 | 9 | 10 |
| | Material | Material | Material | Material | Material | Material | Material | Material | Material | Material |
| | 1 | 2 | 3 | 4 | 5 | 6 | 7 | 8 | 9 | 10 |
| C | 0.004 | 0.004 | 0.003 | 0.004 | 0.003 | 0.004 | 0.004 | 0.004 | 0.004 | 0.004 |
| Si | 0.110 | 0.060 | 0.120 | 0.050 | 0.130 | 0.070 | 0.110 | 0.050 | 0.110 | 0.070 |
| Mn | 0.190 | 0.100 | 0.200 | 0.110 | 0.210 | 0.110 | 0.190 | 0.110 | 0.190 | 0.110 |
| P | 0.024 | 0.023 | 0.026 | 0.022 | 0.022 | 0.024 | 0.024 | 0.039 | 0.040 | 0.024 |
| S | 0.001 | 0.001 | 0.001 | 0.002 | 0.009 | 0.001 | 0.002 | 0.001 | 0.001 | 0.001 |
| Ni | | | | | | | | | | |
| Cr | 14.050 | 17.320 | 14.300 | 17.700 | 14.050 | 17.400 | 14.080 | 17.250 | 14.210 | 17.250 |
| Ti | 0.080 | 0.070 | 0.070 | 0.070 | 0.080 | 0.180 | 0.190 | 0.170 | 0.120 | 0.160 |
| Nb | 0.130 | 0.120 | 0.110 | 0.130 | 0.140 | | | | | |
| Sn | 0.120 | 0.210 | | | 0.050 | 0.005 | | 1.990 | | 0.005 |
| Sb | | | 0.060 | 0.110 | 0.100 | | 0.005 | | 0.980 | 0.005 |
| N | 0.009 | 0.011 | 0.010 | 0.011 | 0.012 | 0.009 | 0.009 | 0.009 | 0.008 | 0.010 |
| Mo | | | | | | | | | | |
| | Electroconductive supporting shaft No | | | | | | | | | |
| | 11 | 12 | 13 | 14 | 15 | 16 | 17 | 18 | 19 | 20 |
| | Material | Material | Material | Material | Material | Material | Material | Material | Material | Material |
| | 11 | 12 | 13 | 14 | 15 | 16 | 17 | 18 | 19 | 20 |
| C | 0.004 | 0.004 | 0.004 | 0.004 | 0.001 | 0.002 | 0.002 | 0.020 | 0.020 | 0.002 |
| Si | 0.110 | 0.080 | 0.120 | 0.080 | 0.010 | 0.090 | 0.080 | 0.090 | 0.500 | 0.090 |
| Mn | 0.200 | 0.100 | 0.200 | 0.100 | 0.200 | 0.100 | 0.180 | 0.100 | 0.180 | 0.100 |
| P | 0.024 | 0.021 | 0.022 | 0.021 | 0.026 | 0.024 | 0.026 | 0.024 | 0.026 | 0.024 |
| S | 0.002 | 0.001 | 0.002 | 0.001 | 0.001 | 0.003 | 0.001 | 0.003 | 0.001 | 0.003 |
| Ni | | | | | | | | | | |
| Cr | 14.110 | 17.330 | 14.080 | 17.400 | 14.810 | 17.600 | 14.080 | 16.980 | 14.810 | 17.720 |
| Ti | 0.130 | 0.160 | 0.190 | 0.180 | 0.021 | 0.180 | 0.020 | 0.490 | | 0.031 |
| Nb | | | | | | 0.020 | 0.021 | | 0.990 | |
| Sn | 0.011 | 0.990 | | | 0.050 | | | 0.011 | 0.990 | |
| Sb | | | 0.005 | 0.490 | 0.100 | 0.110 | 0.120 | | | 0.100 |
| N | 0.009 | 0.007 | 0.009 | 0.009 | 0.001 | 0.003 | 0.004 | 0.019 | 0.020 | 0.005 |
| Mo | | | | | | | | | | |

| | Electroconductive supporting shaft No | | | | | | | | |
|---|---|---|---|---|---|---|---|---|---|
| | 21 | 22 | 23 | 24 | 25 | 26 | 27 | 28 | 29 |
| | Material | Material | Material | Material | Material | Material | Material | Material | Material |
| | 21 | 22 | 23 | 24 | 25 | 26 | 27 | 28 | 29 |
| C | 0.001 | 0.002 | 0.020 | 0.004 | 0.004 | 0.004 | 0.004 | 0.070 | 0.007 |
| Si | 0.080 | 0.080 | 0.090 | 0.070 | 0.110 | 0.080 | 0.120 | 0.290 | 0.310 |
| Mn | 1.000 | 0.100 | 0.050 | 0.110 | 0.190 | 0.110 | 0.170 | 0.600 | 0.180 |
| P | 0.027 | 0.021 | 0.026 | 0.023 | 0.024 | 0.024 | 0.024 | 0.025 | 0.026 |
| S | 0.001 | 0.001 | 0.001 | 0.001 | 0.001 | 0.001 | 0.001 | 0.001 | 0.002 |
| Ni | | | | | | | | 0.110 | 0.130 |
| Cr | 14.330 | 17.680 | 14.420 | 12.010 | 15.030 | 21.980 | 24.890 | 16.230 | 18.400 |
| Ti | | 0.032 | 0.290 | 0.080 | 0.080 | 0.070 | 0.070 | | |
| Nb | 0.052 | 0.051 | 0.580 | 0.120 | 0.130 | 0.120 | 0.130 | | 0.400 |
| Sn | | 0.050 | 0.060 | 0.200 | 0.140 | 0.210 | 0.120 | | |
| Sb | 0.130 | 0.090 | 0.100 | | | | | | |
| N | 0.002 | 0.003 | 0.009 | 0.011 | 0.009 | 0.011 | 0.009 | | 0.010 |
| Mo | | | | | | | | | 1.960 |

[2. Production Examples of Adhesives]

An adhesive 1 and an adhesive 2 shown in Table 2 below were prepared as adhesives for forming adhesive layers each containing a phenol resin.

TABLE 2

| Adhesive No. | Material | Parts by mass |
|---|---|---|
| Adhesive 1 | METALOC U-20 | 100 |
| | (trade name; manufactured by | |
| | Toyokagaku Kenkyusho | |
| | Co., Ltd.) | |
| Adhesive 2 | METALOC N-23 | 100 |
| | (trade name; manufactured by | |
| | Toyokagaku Kenkyusho | |
| | Co., Ltd.) | |
| | Carbon black | 5 |
| | (trade name: “MA100”; | |
| | manufactured by Mitsubishi | |
| | Chemical Corporation) | |

[3. Preparation Examples of Unvulcanized Rubber Compositions]

Materials shown in Table 3 below were mixed with an open roll to provide an unvulcanized rubber composition 1 containing epichlorohydrin.

TABLE 3

| | Part(s) |
|---|---|
| Material | by mass |
| Epichlorohydrin rubber | 100 |
| (trade name; EPION 301; manufactured by Daiso Co., Ltd. | |
| (new company name: Osaka Soda Co., Ltd.)) | |
| Zinc oxide | 5 |
| (zinc oxide of JIS 2 grade manufactured by Seido Chemical | |
| Industry Co., Ltd.) | |
| Tetrabutylammonium perchlorate | 1 |
| (manufactured by Wako Pure Chemical Industries, Ltd.) | |
| Calcium carbonate | 55 |
| (trade name: SILVER W; manufactured by Shiraishi Calcium | |
| Kaisha, Ltd.) | |
| Carbon black | 8 |
| (trade name: SEAST SO; manufactured by Tokai Carbon Co., | |
| Ltd.) | |
| Stearic acid (processing aid) | 2 |
| (manufactured by Kishida Chemical Co., Ltd.) | |
| Adipate (plasticizer) | 10 |
| (trade name: POLYCIZER W305ELS; manufactured by DIC | |
| Corporation) | |
| Sulfur (vulcanizing agent) | 0.5 |
| (trade name: Sulfax; manufactured by Tsurumi Chemical | |
| Industries Co. Ltd.) | |
| Dipentamethylenethiuram tetrasulfide (crosslinking aid) | 2 |
| (trade name: NOCCELER TRA; manufactured by Ouchi Shinko | |
| Chemical Industrial Co., Ltd.) | |

In addition, an unvulcanized rubber composition 2 was obtained in the same manner as in the unvulcanized rubber composition 1 except that the epichlorohydrin rubber was changed to a product available under the trade name “CG-102” from Daiso Co., Ltd. (new company name: Osaka Soda Co., Ltd.).

### EXAMPLE 1

### (1. Formation of Adhesive Layer)

The adhesive 1 was applied over the whole periphery of the 230-mm range of the electroconductive supporting shaft 1 having a total length of 252 mm excluding both of its 11-mm end portions with a roll coater. After the adhesive had been applied, the electroconductive supporting shaft was heated in a hot-air drying furnace at a temperature of 170° C. for 20 minutes to form an adhesive layer.

(2. Formation of Electroconductive Layer)

Next, a crosshead extruder having a mechanism for supplying the electroconductive supporting shaft having formed thereon the adhesive layer and a mechanism for discharging an unvulcanized rubber roller was prepared, and a die having an inner diameter of 12.5 mm was mounted on a crosshead. The temperatures of the extruder and the crosshead were each set to 80° C., and the speed at which the electroconductive supporting shaft having formed thereon the adhesive layer was conveyed was set to 60 mm/sec. The unvulcanized rubber composition 1 was supplied from the extruder under the conditions. Thus, such an unvulcanized rubber roller 1 that the coating layer (electroconductive layer) of the unvulcanized rubber composition 1 was formed on the outer periphery of the electroconductive supporting shaft in the crosshead was obtained.

Next, the unvulcanized rubber roller 1 was loaded into a hot-air vulcanizing furnace at a temperature of 170° C., and was heated for 60 minutes to provide a vulcanized rubber roller. After that, the end portions of the electroconductive layer were cut and removed. Finally, the surface of the electroconductive layer was polished with a rotary grindstone. Thus, an electroconductive elastic roller 1 having a diameter at each of positions distant from its central portion toward both of its end portions by 90 mm each of 8.4 mm, and having a diameter at the central portion of 8.5 mm was obtained.

(3. Formation of Surface Layer)

A solution having a solid content of 18 mass % was prepared by adding methyl isobutyl ketone to a caprolactone-modified acrylic polyol solution. A mixed solution was prepared by mixing 555.6 parts by mass of the solution (solid content of the caprolactone-modified acrylic polyol: 100 parts by mass) with other four kinds of materials shown in Table 4 below.

TABLE 4

| | Part(s) |
|---|---|
| Material | by mass |
| Caprolactone-modified acrylic polyol | 100 |
| (trade name: PLACCEL DC2016; manufactured by Daicel | |
| Chemical Industries, Ltd.) | |
| Carbon black (HAF) | 16 |
| (trade name: MA100; manufactured by Mitsubishi | |
| Chemical Corporation) | |
| Acicular rutile titanium oxide fine particles | 35 |
| (trade name: SMY150IB;; manufactured by Tayca | |
| Corporation) | |
| Modified dimethyl silicone oil | 0.1 |
| (trade name: SH28PA; manufactured by Dow Corning | |
| Toray Co., Ltd.) | |
| 7:3 Mixture of hexamethylene diisocyanate (HDI) and | 80.14 |
| isophorone diisocyanate (IPDI) | |
| (trade name: VESTANAT B1370; manufactured by | |
| Degussa-Hüls AG (EVONIK Industries AG)) | |

210 Grams of the mixed solution and 200 g of glass beads having an average particle diameter of 0.8 mm serving as media were mixed in a 450-mL glass bottle, and were dispersed with a paint shaker disperser for 24 hours. After the dispersion, 5.44 parts by mass (amount corresponding to 20 parts by mass with respect to 100 parts by mass of the acrylic polyol) of crosslinking-type acrylic particles “MR50G” (trade name: manufactured by Soken Chemical & Engineering Co., Ltd.) were added as resin particles to the resultant, and then the mixture was further dispersed for 30 minutes to provide an application liquid 1 for forming a surface layer.

Next, the electroconductive elastic roller 1 was immersed in the application liquid for forming a surface layer while the upper end portion of the electroconductive supporting shaft was held with the longitudinal direction of the roller set to a vertical direction, and the liquid was applied by a dipping method. The time period for which the roller was immersed in the application liquid was set to 9 seconds, the initial and final speeds at which the roller was pulled up from the application liquid were set to 20 mm/s and 2 mm/s, respectively, and the speed was linearly changed with time between these speeds. The resultant applied product was air-dried at 23° C. for 30 minutes. Next, the dried product was dried in a hot-air circulating dryer set to 90° C. for 1 hour. Further, the dried product was dried in a hot-air circulating dryer set to 160° C. for 1 hour to form a surface layer on the outer peripheral surface of the electroconductive elastic roller. Thus, an electroconductive roller 1 was produced, and its performances were evaluated by the following methods.

[4. Performance Evaluations of Electroconductive Roller]

### (4-1. Evaluation for Initial Adhesive Force)

A cut was made in the surface layer of the electroconductive roller 1 along its axial direction with a cutter so as to reach the surface of the electroconductive supporting shaft. Further, a similar cut was made at a position distant from the position of the cut by 5 mm, and the coating layer (electroconductive layer+surface layer) having a width of 5 mm was slowly peeled from the electroconductive supporting shaft with a hand with an end portion thereof as a starting point. The state of a peeling interface at that time was observed, and the result of the evaluation was ranked by the following criteria. It should be noted that when an adhesive force between the electroconductive supporting shaft and the adhesive layer is sufficient, the electroconductive layer or the adhesive layer undergoes a cohesive failure, and when the adhesive force between the electroconductive supporting shaft and the adhesive layer is insufficient, the electroconductive supporting shaft and the adhesive layer easily peel off each other. In addition, an electroconductive roller in which peeling occurred at an interface between an electroconductive supporting shaft and an adhesive layer was not subjected to evaluations “4-2” and thereafter.
Rank A: The peeling occurred by virtue of the cohesive failure of the electroconductive layer or the adhesive layer.
Rank C: The peeling occurred at the interface between the electroconductive supporting shaft and the adhesive layer.

(4-2. Image Evaluation after Standing under High Temperature and High Humidity)

The resultant electroconductive roller was left to stand under a high-temperature and high-humidity environment (temperature: 40° C., relative humidity: 95%) for 1 month, and was then subjected to the following evaluation.

Prepared as an electrophotographic apparatus was an electrophotographic laser printer (trade name: LBP5400, manufactured by Canon Inc.) Reconstructed so as to have a speed at which a recording medium was output of 200 mm/sec and an image resolution of 600 dpi. A charging roller was removed from the cartridge of the electrophotographic apparatus, and the electroconductive roller 1 was incorporated instead, followed by an image evaluation. All image evaluations were performed under low temperature and low humidity (temperature: 15° C., relative humidity: 10%), and a halftone image (such an image that horizontal lines each having a width of 1 dot in a direction vertical to the rotation direction of a photosensitive member were drawn at an interval of 2 dots in the rotation direction) was output and ranked by the following criteria.
Rank A: No white hazy image is present.
Rank C: The image has a white hazy product.

Further, after the evaluation, the resultant electroconductive roller was left to stand under a high-temperature and high-humidity environment (temperature: 40° C., relative humidity: 95%) for 1 month. After that, the same evaluation as the evaluation was performed and the result of the evaluation was ranked by the following criteria.
Rank A: No white hazy image is present.
Rank B: A slight white hazy image is observed but causes no problems in practical use.
Rank C: The image has a white hazy product.

(4-3. Evaluation for Corrosion and Peeling)

With regard to such an electroconductive roller that a white hazy image appeared in the image evaluation after standing under high temperature and high humidity described in the section “4-2”, the electroconductive layer of the electroconductive roller at a position corresponding to a site where the white hazy image appeared was peeled, and the surface of the electroconductive supporting shaft was observed and ranked by the following criteria.
Rank A: No rust occurs.
Rank B: No rust occurs, but extremely slight peeling occurs at the interface between the adhesive layer and the electroconductive supporting shaft.
Rank C: Rust occurs.

The results of the evaluations are shown in Table 6.

### EXAMPLES 2 to 33, AND COMPARATIVE EXAMPLES 1 AND 2

Electroconductive rollers 2 to 33 (Examples 2 to 33), an electroconductive roller C1 (Comparative Example 1), and an electroconductive roller C2 (Comparative Example 2) were each produced in the same manner as in Example 1 except that the electroconductive supporting shaft, the adhesive layer, and the unvulcanized rubber composition for the electroconductive layer were changed as shown in Table 5, and their performances were evaluated. The results of the evaluations are shown in Table 6.

TABLE 5

| | | Electro- | | |
|---|---|---|---|---|
| | Electro- | conductive | | Electro- |
| | conductive | supporting | Adhesive | conductive |
| | roller No | shaft No | layer | layer |
| Example 1 | 1 | 1 | Adhesive 1 | Unvulcanized |
| | | | | rubber |
| | | | | composition 1 |
| Example 2 | 2 | 2 | Same as above | Same as above |
| Example 3 | 3 | 3 | Same as above | Same as above |
| Example 4 | 4 | 4 | Same as above | Same as above |
| Example 5 | 5 | 5 | Same as above | Same as above |
| Example 6 | 6 | 6 | Same as above | Same as above |
| Example 7 | 7 | 7 | Same as above | Same as above |
| Example 8 | 8 | 8 | Same as above | Same as above |
| Example 9 | 9 | 9 | Same as above | Same as above |
| Example 10 | 10 | 10 | Same as above | Same as above |
| Example 11 | 11 | 11 | Same as above | Same as above |
| Example 12 | 12 | 12 | Same as above | Same as above |
| Example 13 | 13 | 13 | Same as above | Same as above |
| Example 14 | 14 | 14 | Same as above | Same as above |
| Example 15 | 15 | 15 | Same as above | Same as above |
| Example 16 | 16 | 16 | Same as above | Same as above |
| Example 17 | 17 | 17 | Same as above | Same as above |
| Example 18 | 18 | 18 | Same as above | Same as above |
| Example 19 | 19 | 19 | Same as above | Same as above |
| Example 20 | 20 | 20 | Same as above | Same as above |
| Example 21 | 21 | 21 | Same as above | Same as above |
| Example 22 | 22 | 22 | Same as above | Same as above |
| Example 23 | 23 | 23 | Same as above | Same as above |
| Example 24 | 24 | 24 | Same as above | Same as above |
| Example 25 | 25 | 25 | Same as above | Same as above |
| Example 26 | 26 | 26 | Same as above | Same as above |
| Example 27 | 27 | 27 | Same as above | Same as above |
| Example 28 | 28 | 1 | Same as above | Unvulcanized |
| | | | | rubber |
| | | | | composition 2 |
| Example 29 | 29 | 2 | Same as above | Same as above |
| Example 30 | 30 | 1 | Adhesive 2 | Unvulcanized |
| | | | | rubber |
| | | | | composition 1 |
| Example 31 | 31 | 2 | Same as above | Same as above |
| Example 32 | 32 | 30 | Adhesive 1 | Same as above |
| Example 33 | 33 | 31 | Same as above | Unvulcanized |
| | | | | rubber |
| | | | | composition 2 |
| Comparative | C1 | 28 | Same as above | Unvulcanized |
| Example 1 | | | | rubber |
| | | | | composition 1 |
| Comparative | C2 | 29 | Same as above | Same as above |
| Example 2 | | | | |

TABLE 6

| | | Image after standing | | |
|---|---|---|---|---|
| | | under high temperature | | |
| | Initial | and high humidity | | Corrosion |
| | adhesive | After 1 | After 2 | and |
| | force | month | months | peeling |
| Example 1 | A | A | A | — |
| Example 2 | A | A | A | — |
| Example 3 | A | A | A | — |
| Example 4 | A | A | A | — |
| Example 5 | A | A | A | — |
| Example 6 | A | A | B | B |
| Example 7 | A | A | B | B |
| Example 8 | A | A | A | — |
| Example 9 | A | A | A | — |
| Example 10 | A | A | B | B |
| Example 11 | A | A | A | — |
| Example 12 | A | A | A | — |
| Example 13 | A | A | A | — |
| Example 14 | A | A | A | — |
| Example 15 | A | A | B | B |
| Example 16 | A | A | B | B |
| Example 17 | A | A | B | B |
| Example 18 | A | A | A | — |
| Example 19 | A | A | A | — |
| Example 20 | A | A | A | — |
| Example 21 | A | A | A | — |
| Example 22 | A | A | A | — |
| Example 23 | A | A | A | — |
| Example 24 | A | A | B | B |
| Example 25 | A | A | A | — |
| Example 26 | A | A | A | — |
| Example 27 | A | A | A | — |
| Example 28 | A | A | A | — |
| Example 29 | A | A | A | — |
| Example 30 | A | A | A | — |
| Example 31 | A | A | A | — |
| Example 32 | A | A | A | — |
| Example 33 | A | A | A | — |
| Comparative | A | C | — | C |
| Example 1 | | | | |
| Comparative | C | — | — | — |
| Example 2 | | | | |

As shown in Table 6, the electroconductive rollers of Examples 1 to 33 each having the adhesive layer containing the phenol resin on the electroconductive supporting shaft of the present invention, and each having the electroconductive layer containing the epichlorohydrin rubber on the adhesive layer are each excellent in initial adhesive force between the electroconductive supporting shaft and the adhesive layer. In addition, even when each of the rollers is left to stand under high temperature and high humidity, the corrosion of the electroconductive supporting shaft can be suppressed. In addition, even when the standing under high temperature and high humidity is prolonged, no problems occur in practical use.

With regard to the electroconductive roller described in Comparative Example 1, a white hazy image occurred in an image after standing under high temperature and high humidity. When the electroconductive layer and the adhesive layer were peeled, and the surface of the electroconductive supporting shaft was observed, it was found that corrosion occurred in a portion corresponding to a site causing white haze on the image. This is interpreted as being because the electroconductive supporting shaft is completely free of titanium, niobium, tin, and antimony that improve its corrosion resistance.

The electroconductive roller described in Comparative Example 2 had an insufficient initial adhesive force between the electroconductive supporting shaft and the adhesive layer. This is interpreted as being because the electroconductive supporting shaft contains molybdenum.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-039019, filed Feb. 27, 2015 which is hereby incorporated by reference herein in its entirety.

What is claimed is:

1. An electroconductive roller, comprising:
an electroconductive supporting shaft;
an adhesive layer on the electroconductive supporting shaft; and
an electroconductive layer on the adhesive layer,
wherein:
the adhesive layer contains a phenol resin;
the electroconductive layer contains an epichlorohydrin rubber;
the electroconductive supporting shaft comprises ferrite-based stainless steel;
a mass % composition of the ferrite-based stainless steel contains:
0.001% to 0.020% of carbon,
0.001% to 0.020% of nitrogen,
0.010% to 0.500% of silicon,
0.050% to 1.000% of manganese,
0.040% or less of phosphorus,
0.010% or less of sulfur,
12.000% to 25.000% of chromium,
at least one of titanium and niobium, the titanium being incorporated at a content of from 0.020% to 0.500%, and the niobium being incorporated at a content of from 0.020% to 1.000%, and
at least one of tin and antimony, the tin being incorporated at a content of from 0.005% to 2.000%, and the antimony being incorporated at a content of from 0.0050% to 1.000%; and
the balance of the composition comprises iron and an inevitable impurity.

2. The electroconductive roller according to claim 1, wherein the electroconductive supporting shaft is obtained by subjecting a metal plate to press working to form the plate into a cylindrical shape.

3. The electroconductive roller according to claim 1 or 2, wherein the epichlorohydrin rubber comprises at least one selected from the group consisting of an epichlorohydrin homopolymer, an epichlorohydrin-ethylene oxide copolymer, and an epichlorohydrin-ethylene oxide-allyl glycidyl ether terpolymer.

4. A process cartridge, comprising:
an electrophotographic photosensitive member; and
a charging roller arranged to be in contact with the electrophotographic photosensitive member,
the process cartridge being removably mounted onto a main body of an electrophotographic apparatus,
wherein the charging roller comprising:
an electroconductive supporting shaft;
an adhesive layer on the electroconductive supporting shaft; and
an electroconductive layer on the adhesive layer,
wherein:
the adhesive layer contains a phenol resin;
the electroconductive layer contains an epichlorohydrin rubber;
the electroconductive supporting shaft comprises ferrite-based stainless steel;
a mass % composition of the ferrite-based stainless steel contains:
0.001% to 0.020% of carbon,
0.001% to 0.020% of nitrogen,
0.010% to 0.500% of silicon,
0.050% to 1.000% of manganese,
0.040% or less of phosphorus, 0.010% or less of sulfur,
12.000% to 25.000% of chromium,
at least one of titanium and niobium, the titanium being incorporated at a content of from 0.020% to 0.500%, and the niobium being incorporated at a content of from 0.020% to 1.000%, and
at least one of tin and antimony, the tin being incorporated at a content of from 0.005% to 2.000%, and the antimony being incorporated at a content of from 0.0050% to 1.000%; and
the balance of the composition comprises iron and an inevitable impurity.

5. An electrophotographic apparatus, comprising:
an electrophotographic photosensitive member; and
a charging roller arranged to be in contact with the electrophotographic photosensitive member,
wherein the charging roller comprising:
an electroconductive supporting shaft;
an adhesive layer on the electroconductive supporting shaft; and
an electroconductive layer on the adhesive layer,
wherein:
the adhesive layer contains a phenol resin;
the electroconductive layer contains an epichlorohydrin rubber;
the electroconductive supporting shaft comprises ferrite-based stainless steel;
a mass % composition of the ferrite-based stainless steel contains:
0.001% to 0.020% of carbon,
0.001% to 0.020% of nitrogen,
0.010% to 0.500% of silicon,
0.050% to 1.000% of manganese,
0.040% or less of phosphorus, 0.010% or less of sulfur,
12.000% to 25.000% of chromium,
at least one of titanium and niobium, the titanium being incorporated at a content of from 0.020% to 0.500%, and the niobium being incorporated at a content of from 0.020% to 1.000%, and
at least one of tin and antimony, the tin being incorporated at a content of from 0.005% to 2.000%, and the antimony being incorporated at a content of from 0.0050% to 1.000%; and
the balance of the composition comprises iron and an inevitable impurity.
